(19) United States
(12) Patent Application Publication
(10) Pub. No.: US 2013/0034715 A1
(43) Pub. Date: Feb. 7, 2013

(54) Method of Fabricating Doped Lutetium Aluminum Garnet (LuAG) or Other Lutetium Aluminum Oxide Based Transparent Ceramic Scintillators

(71) Applicants: Xiaofeng Peng, Shanghai (CN); Qiwei Chen, Shanghai (CN)

(72) Inventors: Xiaofeng Peng, Shanghai (CN); Qiwei Chen, Shanghai (CN)

(73) Assignee: SAINT-GOBAIN CERAMICS & PLASTICS, INC., Worcester, MA (US)

(21) Appl. No.: 13/537,949

(22) Filed: Jun. 29, 2012

Related U.S. Application Data
(60) Provisional application No. 61/594,049, filed on Feb. 2, 2012.

(30) Foreign Application Priority Data
Jun. 29, 2011 (CN) 201110192373.X

(51) Int. Cl. C09K 11/80; C04B 35/64

(52) U.S. Cl. 428/220; 252/301.4 R; 264/679; 264/674

(57) ABSTRACT

Optical quality doped polycrystalline lutetium aluminum garnet (LuAG) scintillator materials having a transmittance in the visible light spectrum greater than 75% and methods for producing same from aluminum oxide and doped lutetium oxide powders.

### CROSS-REFERENCE TO RELATED APPLICATION

The following disclosure is a non-provisional application that claims priority to U.S. Provisional Application No. 60/594,049 filed Feb. 2, 2012, entitled “Method of Fabricating Doped Lutetium Aluminum Garnet (LuAG) or Other Lutetium Aluminum Oxide Based Transparent Ceramic Scintillators” by Xiaofeng Peng et al., and further claims priority to Chinese Application No. 201110192373.X filed Jun. 29, 2011, entitled “Method of Fabricating Doped Lutetium Aluminum Garnet (LuAG) or Other Lutetium Aluminum Oxide Based Transparent Ceramic Scintillators” by Xiaofeng Peng et al., both of which applications are incorporated by reference herein in their entirety for all purposes.

### FIELD OF THE DISCLOSURE

This disclosure, in general, relates to optical quality doped polycrystalline lutetium aluminum garnet (LuAG) scintillator materials and methods for producing same from aluminum oxide and doped lutetium oxide powders.

### BACKGROUND

### Description of the Related Art

Lutetium aluminum garnet, formula Lu₃Al₅O₁₂, also called “LuAG”; when doped with various lanthanide elements show potential for use in a wide variety of applications, including scintillators for nuclear medical imaging applications, such as positron emission tomography (PET) and computerized tomography (CT) scanners, as well as, gamma ray spectroscopy and radiography, laser and neutrino physics applications.

Due to certain limitations related to single crystal doped LuAG materials, much interest has been shown in developing polycrystalline doped LuAG materials suitable as scintillation materials. Desirable properties for such polycrystalline doped LuAG materials include a high transmittance of light in the visible spectrum, quick radio luminescent decay times (fast), radiation capture efficiency (density), light intensity (bright). However, challenges continue to exist in the quest for commercialization of such promising materials.

Doped LuAG materials have been produced before by various methods to form single crystal and polycrystalline materials, however such methods and the materials produced all have certain drawbacks and the industry continues to demand high quality scintillation materials and methods of forming same.

### BRIEF DESCRIPTION OF THE DRAWINGS

The present disclosure can be better understood, and its numerous features and advantages made apparent to those skilled in the art by referencing the accompanying drawings.

FIG. 1 is process flow diagram of an embodiment of a method of forming a polycrystalline doped lutetium aluminum garnet material.

FIG. 2 is a process flow diagram of a method of forming a doped lutetium oxide powder.

FIG. 3 is a process flow diagram of another embodiment of a method of forming a polycrystalline doped lutetium aluminum garnet material.

FIG. 4 is a process flow diagram of a further embodiment of a method of forming a polycrystalline doped lutetium aluminum garnet material.

FIG. 5 is a transmission electron micrograph (TEM) of a doped lutetium oxide powder suitable for use in forming embodiments of polycrystalline doped lutetium aluminum garnet material.

FIG. 6 is a scanning electron micrograph (SEM) of doped lutetium oxide powder suitable for use in forming embodiments of polycrystalline doped lutetium aluminum garnet material.

FIG. 7 is a TEM of an aluminum oxide powder suitable for use in forming embodiments of polycrystalline doped lutetium aluminum garnet material.

FIG. 8 is another TEM of an aluminum oxide powder suitable for use in forming embodiments of polycrystalline doped lutetium aluminum garnet material.

FIG. 9 is a photograph of an embodiment of a polycrystalline doped lutetium aluminum garnet material in the form of a transparent disk having a 15.5 mm diameter and a thickness of approximately 4 mm.

FIG. 10 is a graph of percent transmittance of electromagnetic radiation according to wavelength for an embodiment of a polycrystalline doped lutetium aluminum garnet material.

FIG. 11 is a graph of percent transmittance of electromagnetic radiation according to wavelength for an embodiment of a polycrystalline doped lutetium aluminum garnet material.

The use of the same reference symbols in different drawings indicates similar or identical items.

### DETAILED DESCRIPTION

Polycrystalline doped lutetium aluminum garnet (LuAG) material is useful as a scintillator material when it has been produced in such a manner as to possess a high transmissivity in particular portions of the electromagnetic radiation spectrum, including the near ultraviolet (UV), visible light, near infrared (IR), and combination thereof. High transmission in the near UV, blue light, and green light can help to improve transmission of photons to a photo sensor and thus improve a signal-to-noise ratio for a radiation detector.

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The term “averaged,” when referring to a value, is intended to mean an average, a geometric mean, or a median value.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

As used herein, a material is “doped” when it includes a dopant at a concentration of at least 1 ppm. For example, a lutetium oxide is a doped lutetium oxide when a dopant is present in an amount greater than 1 ppm.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

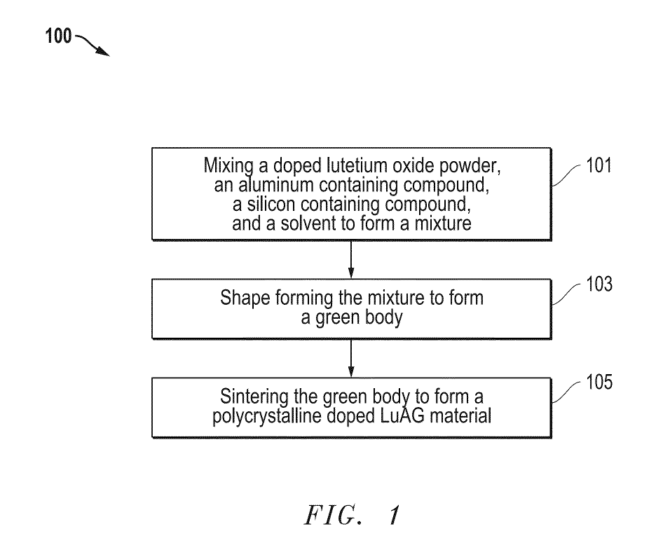

FIG. 1 shows a particular embodiment of a method 100 of forming a polycrystalline doped lutetium aluminum garnet scintillator material. The process is initiated atactivity 101 by mixing a doped lutetium oxide powder, an aluminum containing compound, a silicon containing compound, and a solvent to form a mixture. Shape forming the mixture to form a green body occurs in activity 103. In activity 105, sintering of the green body to form the polycrystalline doped lutetium aluminum garnet material occurs.

Turning to the doped lutetium oxide powder, the type and amount of dopant in the lutetium oxide powder corresponds to the type and amount of dopant in the formed polycrystalline doped lutetium aluminum garnet material. In an embodiment, the doped lutetium oxide powder can be doped with a Lanthanide element. In another embodiment, the dopant is at least one of the group consisting of lanthanum (La), cerium (Ce), praseodymium (Pr), neodymium (Nd), promethium (Pm), samarium (Sm), europium (Eu), gadolinium (Ga), terbium (Tb), dysprosium (Dy), holmium (Ho), erbium (Eb), thulium (Tm), ytterbium (Yb), and combinations thereof. In another embodiment, the dopant is at least one of the group consisting of cerium (Ce), praseodymium (Pr), terbium (Tb), and combinations thereof. In particular embodiments, the dopant is cerium (Ce), praseodymium (Pr), or terbium (Tb).

The amount of dopant in the lutetium oxide powder can vary depending on the desired application, such as scintillation. In an embodiment, the amount of dopant in the lutetium oxide powder is at least about 0.0002 mole %, at least about 0.002 mole %, at least about 0.02 mole %, at least about 0.1 mole %, at least about 0.5 mole %, or at least about 1.0 mole %. In another embodiment, the amount of dopant in the lutetium oxide powder is not greater than about 20 mole %, not greater than about 15 mole %, not greater than about 10 mole %, not greater than about 5 mole %, not greater than about 3 mole %, or not greater than about 1 mole %. The amount of dopant in the lutetium oxide powder can be in the range of about 0.1 mole % to about 10 mole %. The amount of dopant in the lutetium oxide powder can be within a range comprising any pair of the previous upper and lower limits. In a particular embodiment the amount of dopant in the lutetium oxide powder is in the range of about 0.1 mole % to about 5.0 mole %.

In an embodiment the aluminum containing compound is an aluminum oxide powder.

Regarding the doped lutetium oxide powder and the aluminum oxide powder, the inventors have identified that suitably doped lutetium oxide powders and aluminum oxide powders have a combination of particular desirable physical properties that are believed to aid in the sintering 105 to promote transparency in the visible light spectrum of the polycrystalline doped LuAG material. In an embodiment, the powder particles are near spherical to spherical (i.e., substantially equiaxed) in shape, have low agglomeration, have a particular specific surface area range, have a particular average particle size range, and have a particular density range.

Specific surface area can be obtained by gas adsorption using the Brunauer Emmett Teller (BET) method. In an embodiment, the doped lutetium oxide powder can have a specific surface area not less than about 5 m²/g, not less than about 10 m²/g, not less than about 11 m²/g, not less than about 12 m²/g, not less than about 13 m²/g, or not less than about 14 m²/g. In another embodiment, the doped lutetium oxide powder is not greater than about 25 m²/g, such as not greater than about 20 m²/g, not greater than about 19 m²/g, not greater than about 18 m²/g, not greater than about 17 m²/g, not greater than about 16 m²/g, not greater than about 15 m²/g. The specific surface area of the lutetium oxide powder can be within a range comprising any pair of the previous upper and lower limits. In a particular embodiment, the doped lutetium oxide powder can have a specific surface area in the range of not less than about 12 m²/g to not greater than about 17 m²/g.

In an embodiment, the doped lutetium oxide powder can have a density in the range of not less than about 9.0 g/cm³, not less than about 9.1 g/cm³, not less than about 9.2 g/cm³, not less than about 9.3 g/cm³, or not less than about 9.4 g/cm³. In another embodiment, the doped lutetium oxide powder is not greater than about 10.0 g/cm³, not greater than about 9.9 g/cm³, not greater than about 9.8 g/cm³, not greater than about 9.7 g/cm³, not greater than about 9.6 g/cm³, not greater than about 9.5 g/cm³. The density of the lutetium oxide powder can be within a range comprising any pair of the previous upper and lower limits. In a particular embodiment, the doped lutetium oxide powder can have a density in the range of not less than about 9.2 g/cm³ to not greater than about 9.6 g/cm³.

As used herein, particle size is used to denote the average longest or length dimension of the particles. For example, when particles exhibit a spherical or nearly spherical shape, particle size can be used to denote average particle diameter. In an embodiment, the particle size can be calculated based on the BET specific surface area and the density. In another embodiment, average particle size can be measured using x-ray diffraction analysis (XRD) or laser diffraction analysis. In another embodiment, average particle size can be determined by taking multiple representative samples and measuring the particle sizes found in representative sample images taken by various characterization techniques, such as by scanning electron microscopy (SEM), transmission electron microscopy (TEM). Particle size relates to individually identifiable particles. Additionally, the average particle size as determined based on XRD, laser diffraction, or BET can be compared to the averaged particle size as determined by SEM and TEM to determine whether the agglomeration of particles is low.

In an embodiment, the doped lutetium oxide powder can have an averaged particle size, based on BET specific surface area, of at least about 40 nm, such as at least about 42 nm, or at least about 44 nm. In another embodiment, the doped lutetium oxide powder can have an averaged particle size, based on BET specific surface area, of not greater than about 50 nm, such as not greater than about 48 nm, not greater than about 46 nm, or not greater than about 45 nm. The doped lutetium oxide powder can have an averaged particle size, based on BET specific surface area, within a range comprising any pair of the previous upper and lower limits. In a particular embodiment, the doped lutetium oxide powder can have an averaged particle size, based on BET specific surface area, of not less than about 40 nm to not greater than about 46 nm.

In another embodiment, the doped lutetium oxide powder can have an averaged particle size, based on SEM measurement, not less than 35 nm, such as not less than 37 nm, not less than 39 nm, not less than 41 nm, not less than 43 nm, or not less than 45 nm. In another embodiment, the doped lutetium oxide powder can have an averaged particle size, based on SEM measurement not greater than about 55 nm, such as not greater than about 53 nm, not greater than about 51 nm, not greater than about 49 nm, not greater than about 47 nm, or not greater than about 45 nm. The doped lutetium oxide powder can have an averaged particle size, based on SEM measurement, within a range comprising any pair of the previous upper and lower limits. In a particular embodiment, the doped lutetium oxide powder can have an averaged particle size, based on SEM measurement, of not less than about 40 nm to not greater than about 50 nm.

In another embodiment, the doped lutetium oxide powder can have an averaged particle size, based on XRD measurement, of not less than about 20 nm, such as not less than about 22 nm, not less than about 24 nm, not less than about 26 nm, not less than about 28 nm, or not less than 30 nm. In another embodiment, the doped lutetium oxide powder can have an averaged particle size, based on XRD measurement, of not greater than about 40 nm, such as not greater than about 38 nm, not greater than about 36 nm, not greater than about 34 nm, not greater than about 32 nm, or not greater than about 30 nm. The doped lutetium oxide powder can have an averaged particle size, based on XRD measurement, within a range comprising any pair of the previous upper and lower limits. In a particular embodiment, the doped lutetium oxide powder can have an averaged particle size, based on XRD measurement, of not less than about 25 nm to not greater than about 35 nm.

In another embodiment, the doped lutetium oxide powder can have a D₅₀ particle size, based on laser diffraction measurement, of not less than about 85 nm, such as not less than about 90 nm, not less than about 95 nm, not less than about 100.

In another embodiment, the doped lutetium oxide powder can have a D₅₀ particle size, based on laser diffraction measurement, of not greater than about 125 nm, such as not greater than about 120 nm, not greater than about 115 nm, not greater than about 110 nm. The doped lutetium oxide powder can have a D₅₀ particle size, based on laser diffraction measurement, within a range comprising any pair of the previous upper and lower limits. In a particular embodiment, the doped lutetium oxide powder can have a D₅₀ particle size, based on laser diffraction measurement, of not less than about 100 nm to not greater than about 110 nm.

In any of the foregoing and following particle sizes, the averaged particle size may be an average particle size or a median particle size.

In an embodiment, the doped lutetium powder has an averaged particle size, based on BET specific surface area, ranging from about 30 nm to about 65 nm; a specific surface area ranging from about 10 m²/g to about 20 m²/g; and a density ranging from about 9.0 g/cm³ to about 10.0 g/cm³. In a particular embodiment, the doped lutetium powder has an averaged particle size, based on BET specific surface area, ranging from about 40 nm to about 46 nm; a specific surface area ranging from about 12 m²/g to about 18 m²/g; and a density ranging from about 9.3 g/cm³ to about 9.5 g/cm³.

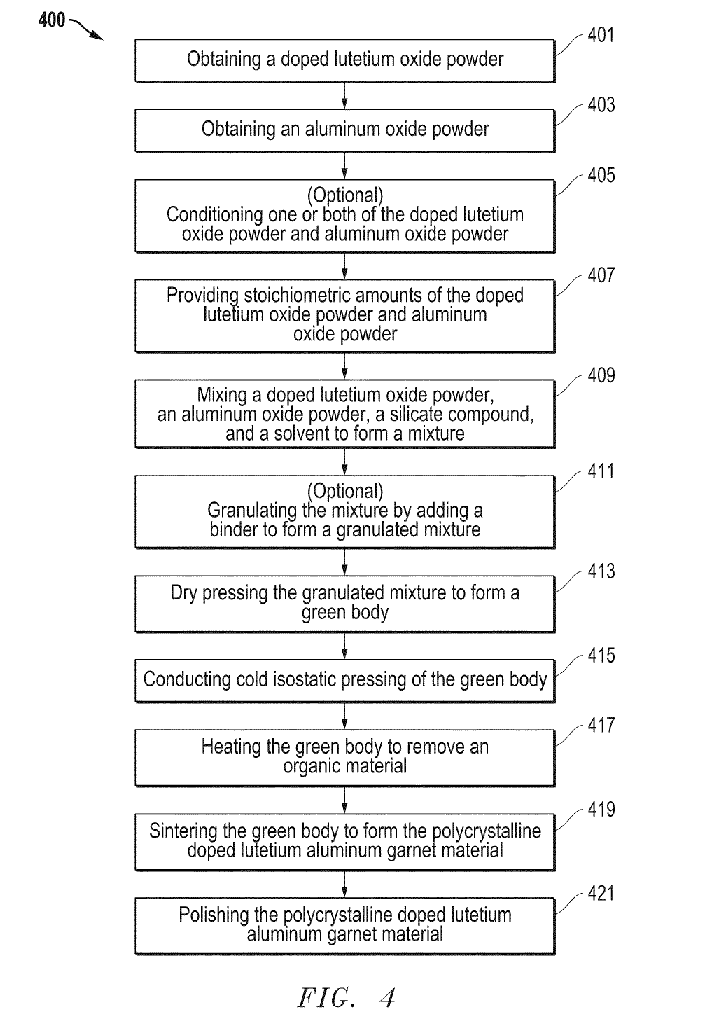

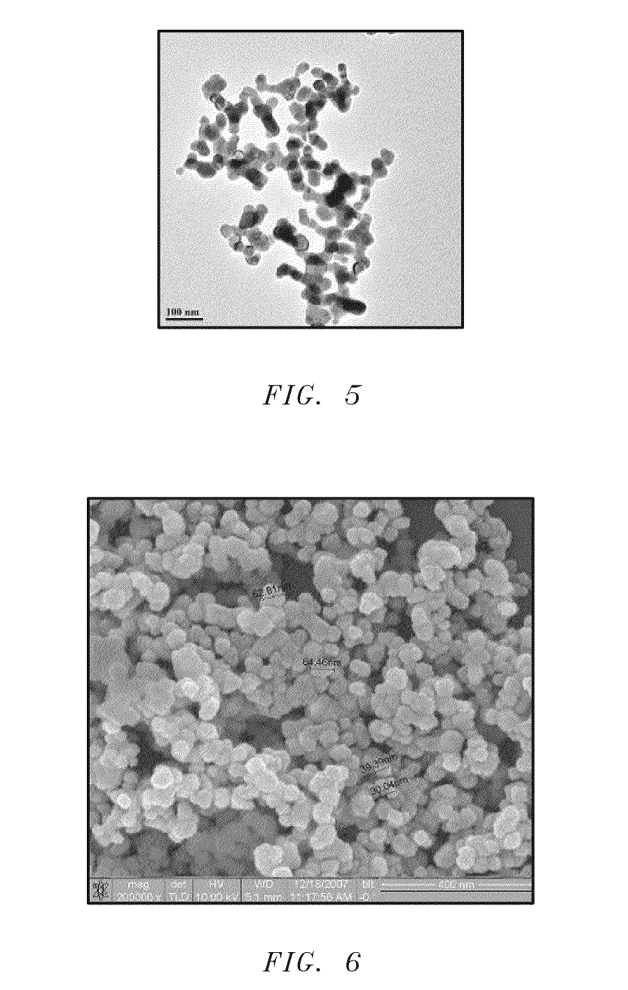

FIG. 5 and FIG. 6 show an embodiment of doped lutetium oxide powder, specifically LuAG: 0.5 mole % Pr, having: near spherical shaped particles; a specific surface of about 15.3 m²/g; a density of about 9.4 g/cm³; an average particle size of about 42 nm based on BET specific surface area; an average particle size of about 30 nm as measured by XRD method, an average particle size in the range of about 40 nm to about 50 nm as measured by SEM method, and a D₅₀ particle size based on laser diffraction measurement of about 106 nm.

Turning to the physical properties of the aluminum oxide powder, in an embodiment, the aluminum oxide powder has a specific surface area not less than about 18 m²/g, such as not less than about 20 m²/g, or not less than about 22 m²/g. In another embodiment, the aluminum oxide powder has a specific surface area not greater than about 40 m²/g, such as not greater than about 35 m²/g, not greater than about 30 m²/g, or not greater than about 25 m²/g. The specific surface area of the aluminum oxide powder can be within a range comprising any pair of the previous upper and lower limits. In particular embodiment, the aluminum oxide powder has a specific surface area in the range of not less than about 18 m²/g to not greater than about 30 m²/g.

In an embodiment, the aluminum oxide powder has a density of not less than about 3.0 g/cm³, such as not less than about 3.3 g/cm³, not less than about 3.5 g/cm³, not less than about 3.7 g/cm³, or not less than about 3.9 g/cm³. In another embodiment, the doped aluminum oxide powder is not greater than about 4.75 g/cm³, such as not greater than about 4.5 g/cm³, not greater than about 4.25 g/cm³, or not greater than about 4.0 g/cm³. The density of the aluminum oxide powder can be within a range comprising any pair of the previous upper and lower limits. In a particular embodiment, the aluminum oxide powder has a density in the range of not less than about 3.5 g/cm³ to not greater than about 4.3 g/cm³.

In an embodiment, the aluminum oxide powder can have an averaged particle size, based on BET specific surface area, of at least about 55 nm, such as at least about 60 nm, or at least about 65 nm. In another embodiment, the aluminum oxide powder can have an averaged particle size, based on BET specific surface area, of not greater than about 85 nm, such as not greater than about 80 nm, or not greater than about 75 nm. The aluminum oxide powder can have an averaged particle size, based on BET specific surface area, within a range comprising any pair of the previous upper and lower limits. In a particular embodiment, the aluminum oxide powder can have an averaged particle size, based on BET specific surface area, of at least about 65 nm to not greater than about 75 nm.

In another embodiment, the aluminum oxide powder can have an averaged particle size, based on SEM measurement, not less than 55 nm, such as not less than 60 nm, not less than 65 nm. In another embodiment, the aluminum oxide powder can have an averaged particle size, based on SEM measurement not greater than about 85 nm, such as not greater than about 80 nm, not greater than about 75 nm. The aluminum oxide powder can have an averaged particle size, based on SEM measurement, within a range comprising any pair of the previous upper and lower limits. In a particular embodiment, the aluminum oxide powder can have an averaged particle size, based on SEM measurement, of not less than about 65 nm to not greater than about 75 nm.

In another embodiment, the aluminum oxide powder can have a D₅₀ particle size, based on laser diffraction measurement, of not less than about 40 nm, such as not less than about 50 nm, not less than about 60 nm, not less than about 70 nm. In another embodiment, the aluminum oxide powder can have a D₅₀ particle size, based on laser diffraction measurement, of not greater than about 100 nm, such as not greater than about 90 nm, not greater than about 80 nm, not greater than about 75 nm. The aluminum oxide powder can have a D₅₀ particle size, based on laser diffraction measurement, within a range comprising any pair of the previous upper and lower limits. In a particular embodiment, the aluminum oxide powder can have a D₅₀ particle size, based on laser diffraction measurement, of not less than about 40 nm to not greater than about 100 nm.

In any of the foregoing and following particle sizes, the averaged particle size may be an average particle size or a median particle size.

In an embodiment, the aluminum oxide powder has an averaged particle size, as calculated based on BET specific surface area, ranging from at least about 65 nm to about 75 nm; a specific surface area ranging from at least about 18 m²/g to about 25 m²/g; and a density ranging from at least about 3.5 g/cm³ to about 4.3 g/cm³.

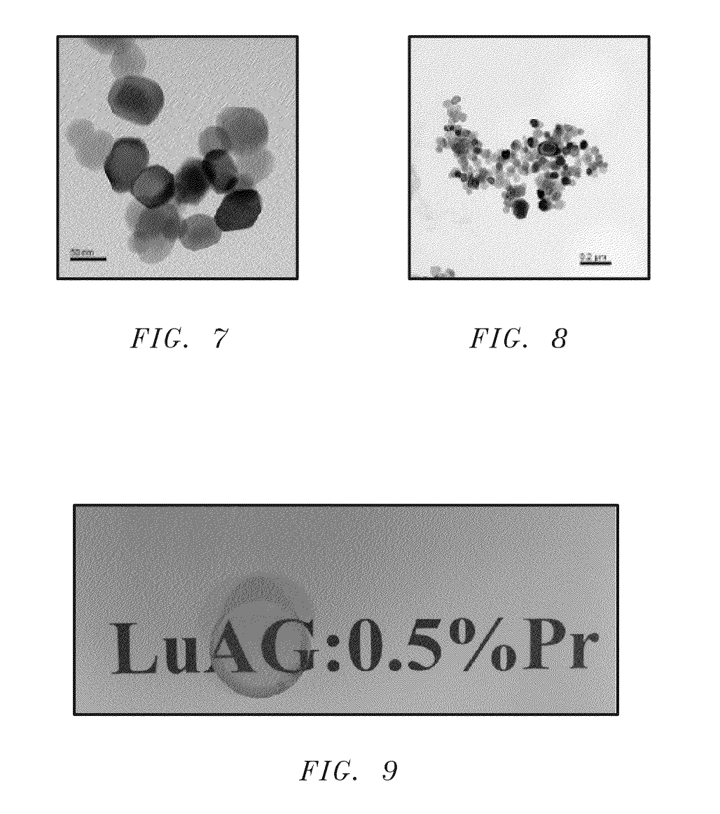

FIG. 7 and FIG. 8 show an embodiment of aluminum oxide powder, having: near spherical shaped particles; a specific surface area of about 22.7 m²/g; a density of about 3.9 g/cm³; an average particle size, based on BET surface area, of about 70 nm, an average particle size about 70 nm as measured by SEM method, and a D₅₀ particle size based on laser diffraction measurement in the range of about 40 nm to less than 100 nm.

Any doped lutetium oxide powder or aluminum oxide powder exhibiting the above described combination of particular properties will be suitable for use in the embodied methods of producing a polycrystalline doped lutetium aluminum garnet material. Suitable doped lutetium oxide powders are available from Saint-Gobain Research (Shanghai) Co. Ltd. (Shanghai, China). Suitable aluminum oxide powder is available from Saint-Gobain Ceramics and Plastics, Inc. (Worcester, Mass., USA).

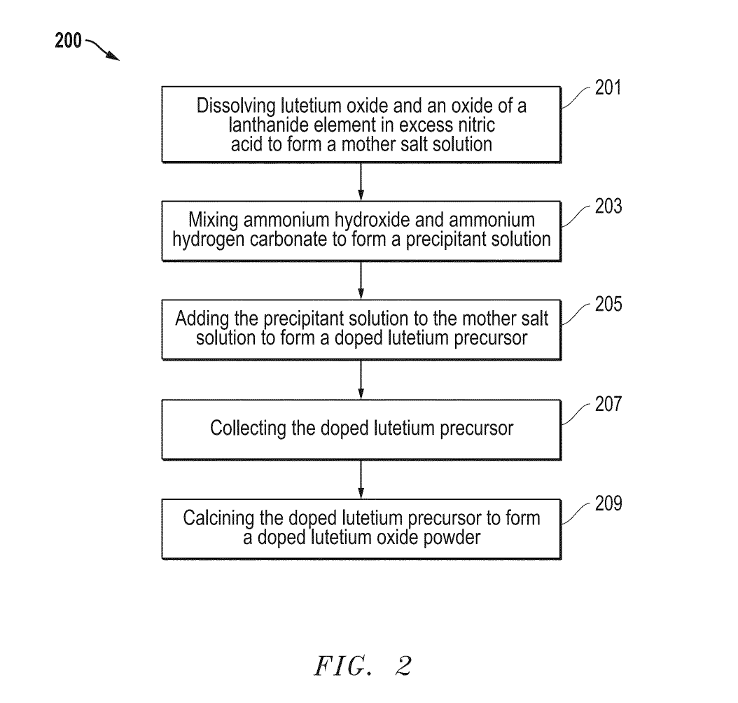

As shown in FIG. 2, in a particular embodiment a method 200 of forming a suitable doped lutetium oxide powder includes: dissolving lutetium oxide and an oxide of a lanthanide element in excess nitric acid to form a mother salt solution (activity 201); mixing ammonium hydroxide and ammonium hydrogen carbonate to form a precipitant solution (activity 203); adding the precipitant solution to the mother salt solution to form a doped lutetium precursor (activity 205); collecting the doped lutetium precursor (activity 207); and calcining the doped lutetium precursor to form a doped lutetium oxide powder (activity 209).

In the above method, the amount of dopant that is added is compensated for by an equivalent decrease in the amount of lutetium oxide. For example, in an embodiment, if the concentration of dopant is set at 0.5 mole %, this is compensated for by an equivalent decrease of the lutetium oxide. Also, the resulting suspension formed during activity 205 can be aged if desired, such as up to 24 hours, prior to collection of the doped lutetium precursor, or instead can be immediately collected. Collection of the doped lutetium precursor precipitate during activity 207 can be accomplished by any of various techniques, including filtration, decanting, or centrifugation, and can include washing and drying of the doped lutetium precursor. The doped lutetium precursor can be crushed prior to calcining in activity 209.

Returning back to FIG. 1, activity 101, stoichiometric amounts of the doped lutetium oxide powder and the aluminum containing compound, such as aluminum oxide powder, are used. In an embodiment, stoichiometric amounts of the doped lutetium oxide powder and the aluminum containing compound are mixed together along with a silicon containing compound, and a solvent to form a mixture. Optionally, the mixture can also include a dispersant. In an embodiment, the mixture includes stoichiometric amounts of the doped lutetium oxide powder and the aluminum containing compound, a silicon containing compound, a solvent, and a dispersant.

During activity 101, the silicon containing compound acts as a sintering aid. In an embodiment, the silicon containing compound is a silicon oxide. In another embodiment, the silicon containing compound is a silicate compound. In a particular embodiment, the silicate compound is tetraethyl orthosilicate. In an embodiment, the amount of silicon containing compound in the mixture is not less than about 0.01 wt %, such as not less than about 0.03 wt %, or not less than about 0.05 wt % of the combined total weight of the lutetium oxide powder and the aluminum containing compound. In another embodiment, the amount of silicon containing compound in the mixture is not greater than about 1.0 wt %, such as not greater than about 0.09 wt %, or not greater than about 0.08 wt % of the combined total weight of the lutetium oxide powder and the aluminum containing compound. The amount of silicon containing compound in the mixture can be within a range comprising any pair of the previous upper and lower limits. In a particular embodiment, tetraethyl orthosilicate is present in the mixture in an amount ranging from about at least about 0.05 wt % to not greater than about 0.8 wt % of the combined total weight of the lutetium oxide powder and the aluminum oxide powder.

In an embodiment, the solvent has a hydroxy group. In another embodiment, the solvent is a silyl or an alcohol. In another embodiment, the solvent is an alcohol having from one to six constituent carbons. In a particular embodiment, the solvent is ethyl alcohol. In an embodiment, the amount of solvent in the mixture is at least about 1% by volume of the mixture, such as at least about 5% by volume of the mixture, or at least about 8% by volume of the mixture. In another embodiment, the amount of solvent in the mixture is not greater than about 20% by volume of the mixture, such as not greater than about 15% by volume of the mixture, or not greater than about 12% by volume of the mixture. The amount of solvent in the mixture can be within a range comprising any pair of the previous upper and lower limits. In a particular embodiment, the amount of solvent in the mixture is in the range of about 8% to about 12% by volume of the mixture.

Although optional, the mixture may contain a dispersant. In an embodiment the dispersant can be a polyether glycol (PEG), a polyacrylic acid (PAA), a polyethylene imine (PEI), or combinations thereof. In an embodiment, the amount of dispersant in the mixture is greater than about 0.5 wt %, such as greater than about 0.75 wt %, or greater than about 1.0 wt % of the total weight of the lutetium oxide powder and aluminum containing compound. In another embodiment, the amount of dispersant in the mixture is less than about 3.0 wt %, such as less than about 2.0 wt %, or less than about 1.5 wt % of the total weight of the lutetium oxide powder and aluminum containing compound. The amount of dispersant in the mixture can be within a range comprising any pair of the previous upper and lower limits. In a particular embodiment, the amount of dispersant in the mixture is in the range of about 0.8 wt % to about 1.5 wt % of the total weight of the lutetium oxide powder and aluminum containing compound.

During activity 101, mixing of the mixture can be accomplished by any suitable method or device for mixing nano sized powders including, tumbling mixers, convective mixers, fluidized bed mixers, high-shear mixers, ultrasonic mixers, media mills, hammer mills, or ball mills Mixing relates to the amount of energy expended and input to a mixture to achieve sufficient homogeneity of the mixture. Depending on the mixing method or device, certain mixing parameters can vary, however the amount of energy input to the mixture to achieve sufficient homogeneity of the mixture will still be comparable. In an embodiment, the mixing method is ball milling. One of skill in the art will recognize that mixing parameters may be adjusted for different embodiments. Such adjustments are within the skill of those in the art.

Turning to activity 103, the mixture is shaped formed into a green body. Shape forming can be accomplished through any of various methods known in the ceramics art including casting; such as slip casting, shell casting, net casting, hydraulic casting, gel casting, and tape casting; molding, including injection molding; and powder pressing operations, including dry pressing, isostatic pressing, and wet bag pressing. Isostatic pressing can be hot isostatic pressing or cold isostatic pressing. In a particular embodiment, the shape forming can comprise granulating the mixture to form a granulated mixture and pressing the granulated mixture to form a green body.

During activity 103, shape forming can be performed so as to create a green body having a regular or irregular shape, including a geometric shape. In an embodiment, the green body, and thus the resulting scintillator material, can be in the form of at least one of the group consisting of a slab, a sheet, a disk, a rod, a cube, a rectangular prism, a tetrahedron, a pyramid, a cone, and a sphere. In a specific embodiment, the green body is shape formed into a disk.

During activity 105, the green body is sintered to form a polycrystalline doped lutetium aluminum garnet material. Sintering can be accomplished by various methods and devices known in the art. In an embodiment, sintering of the green body occurs under vacuum. In another embodiment, sintering of the green body is conducted in a hydrogen atmosphere. In an embodiment, the sintering occurs at a sintering temperature in the range of at least about 1650° C. to not greater than about 1850° C. The sintering can occur for a period of time ranging from at least about 4 hours to not greater than about 12 hours. In a particular embodiment, the green body is sintered in a vacuum furnace at a sintering temperature in the range of at least about 1700° C. to not greater than about 1800° C. for a period of time ranging from at least about 4 hours to not greater than about 12 hours.

The resulting polycrystalline doped lutetium aluminum garnet material has many useful properties, particularly with regard to use as a scintillator material. Before addressing these useful properties in greater detail, we turn to an alternate embodiment of a method of producing a polycrystalline doped lutetium aluminum garnet material.

FIG. 3 shows an embodiment of forming a polycrystalline doped lutetium aluminum garnet material including: obtaining a doped lutetium oxide powder (activity 301); obtaining an aluminum oxide powder (activity 303); optionally, conditioning one or both of the doped lutetium oxide powder and the aluminum oxide powder (activity 305); providing stoichiometric amounts of the doped lutetium oxide powder and the aluminum oxide powder (activity 307); mixing the stoichiometric amounts of the doped lutetium oxide powder and the aluminum oxide powder with a silicate compound and a solvent to form a mixture (activity 309); optionally, granulating the mixture by adding a binder to form a granulated mixture (activity 311); pressing the granulated mixture to form a green body (activity 313); heating the green body to remove an organic material (activity 315); and sintering the green body to form the polycrystalline doped lutetium aluminum garnet material (activity 317).

As previously stated, any doped lutetium oxide powder or aluminum oxide powder exhibiting the already described combination of particular properties will be suitable for use in the embodied method 300 of producing a polycrystalline doped lutetium aluminum garnet material. Suitable doped lutetium oxide powders can be obtained from Saint-Gobain Research (Shanghai) Co. Ltd. (Shanghai, China) or produced according to the method illustrated in FIG. 2 and described above. Suitable aluminum oxide powder can be obtained Saint-Gobain Ceramics and Plastics, Inc. (Worcester, Mass., USA).

During activity 305, conditioning of one or both of the doped lutetium oxide powder and the aluminum oxide powder is optional, but can be performed to substantially eliminate contaminants such as residual moisture or organic materials from the powders. Powder conditioning may help to promote transparency of the resulting polycrystalline doped lutetium aluminum garnet material. Powder conditioning encompasses the substantial elimination of residual organic materials, or residual moisture, or both, from the doped lutetium oxide powder and the aluminum oxide powder. If there is no significant concern that the doped lutetium oxide powder or the aluminum oxide powder might contain residual organic materials or residual moisture, powder conditioning need not be performed prior to mixing of the powders. Powder conditioning can include calcining, drying, or both.

If it is unknown whether one or both of the powders are thought to contain organic materials, conditioning of one or both powders can be accomplished by calcining. In an embodiment, calcining can be conducted at a temperature of at least about 650° C. to not greater than about 1100° C. Calcining can occur for a period of about one to eight hours. Calcining can be performed in any suitable furnace or oven, such as a muffle furnace. In an embodiment, calcining is performed at a temperature of about 1000° C. for about four hours in a muffle furnace.

If only the presence of moisture is a concern, conditioning of one or both of the powders can be accomplished by drying. In an embodiment, drying can be conducted at a temperature of at least about 120° C. to about 200° C. Drying can occur for a period of about one to eight hours. Drying can be performed in any suitable furnace or oven, such as a drying oven. In a particular embodiment, drying can be conducted at a temperature of about 180° C. for about 8 hours in a muffle furnace.

During activity 307, providing and maintaining stoichiometric amounts of the doped lutetium oxide powder and the aluminum oxide powder throughout the production process will help to promote transparency of the resulting polycrystalline doped lutetium aluminum garnet scintillator material.

During activity 309, mixing the stoichiometric amounts of the doped lutetium oxide powder and the aluminum oxide powder with a silicate compound and a solvent to form a mixture is conducted as previously described above in relation to FIG. 1.

During activity 311, granulating the mixture is optional, but can be done to improve the handleability of the mixture, such as when the particles of the mixture are superfine in size (about 50 nm or less). Granulation may also promote formation of the green body. In an embodiment, the mixture undergoes granulation to form a granulated mixture. Granulating can be accomplished by various methods including adding a binder to the mixture and spray drying, sieve granulating, freeze-drying, or vacuum-granulating. The binder can be an organic compound, such as a polyvinyl alcohol (PVA). In an embodiment, binder is added to the mixture, which is then sieved to form a granulated mixture. In a particular embodiment, the amount of PVA added to the mixture is at a ratio of about 1 g of PVA per 20 g of combined doped lutetium oxide powder and aluminum oxide powder in the mixture.

During activity 313, pressing of the granulated mixture to form a green body can be accomplished in one or more successive steps by the same or differing pressing techniques. Pressing includes dry pressing, isostatic pressing, wet bag pressing, or combinations thereof. Isostatic pressing can be hot isostatic pressing or cold isostatic pressing.

During activity 315, heating the green body to remove one or more residual organic materials may help to promote sintering and transparency of the resulting polycrystalline doped lutetium aluminum garnet material. In an embodiment, the green body undergoes heat treatment to remove any residual organic compounds. In an embodiment, the green body is heated at a temperature ranging from at least about 600° C. to not greater than about 1000° C. The heating can occur for a period of time ranging from at least about 0.5 hours to not greater than 4 hours. In a particular embodiment, after pressing, the green body is heated at a temperature ranging from at least about 750° C. to not greater than about 850° C. for a period of time ranging from at least about 1 hour to not greater than about 3 hours.

During activity 317, sintering of the green body can be performed using any of the embodiments described above in relation to FIG. 1.

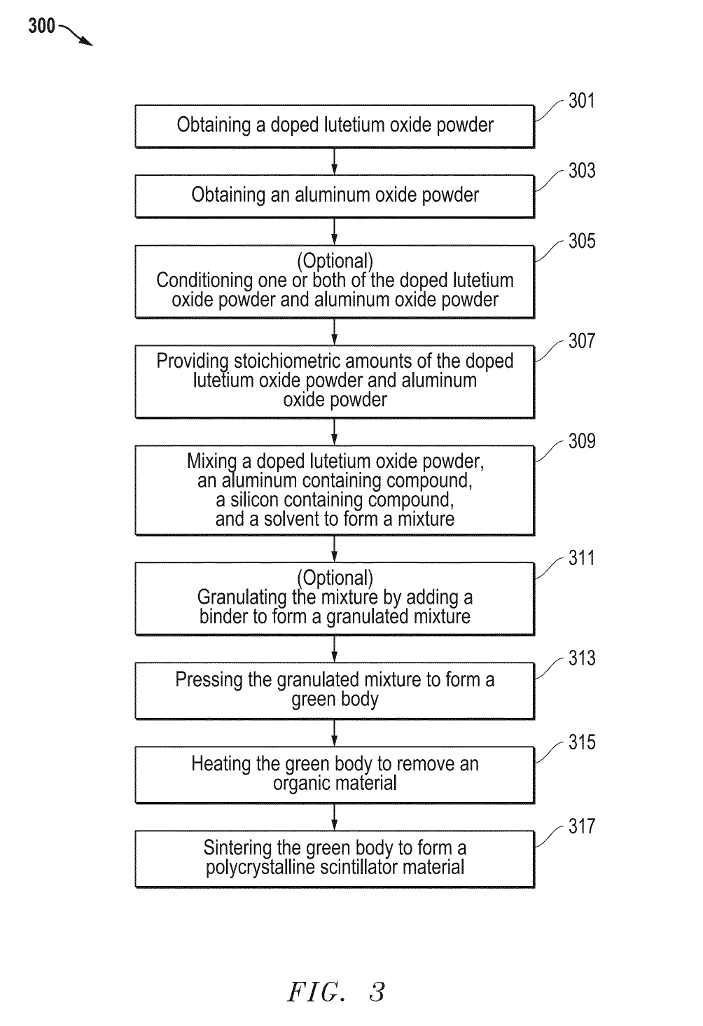

FIG. 4 shows another embodiment of a method of forming a polycrystalline doped lutetium aluminum garnet material including: obtaining a doped lutetium oxide powder (activity 401); obtaining an aluminum oxide powder (activity 403); optionally, conditioning one or both of the doped lutetium oxide powder and the aluminum oxide powder (activity 405); providing stoichiometric amounts of the doped lutetium oxide powder and the aluminum oxide powder (activity 407); mixing the stoichiometric amounts of the doped lutetium oxide powder and the aluminum oxide powder with a silicate compound and a solvent to form a mixture (activity 409); optionally, granulating the mixture by adding a binder to form a granulated mixture (activity 411); dry pressing the granulated mixture to form a green body (activity 413); conducting cold isostatic pressing of the green body (activity 415); heating the green body to remove an organic material (activity 417); and sintering the green body to form the polycrystalline doped lutetium aluminum garnet material (activity 419).

Activities 401 through 411 can be performed using any of the embodiments described above in relation to FIG. 3.

During activity 413, dry pressing the granulated mixture to form a green body can be accomplished by various methods and devices known in the art. In an embodiment, dry pressing can be conducted in a pressure range of at least about 10 MPa to not greater than 50 Mpa. In an embodiment, the granulated mixture is dry pressed to form a green body at a pressure in the range of at least about 20 MPa to not greater than 40 Mpa for a period of time ranging from about 1 minute to about 15 minutes.

During activity 415, isostatic pressing can be conducted on the green body. In an embodiment, the isostatic pressing is cold isostatic pressing. The cold isostatic pressing can occur at a pressure ranging from at least about 120 MPa to not greater than about 500 MPa. The cold isostatic pressing occurs for a period of time ranging from at least 10 minutes to not greater than about 60 minutes. In an embodiment, after dry pressing, the green body undergoes cold isostatic pressing at a pressure ranging from at least about 180 MPa to not greater than about 210 MPa for a period of time ranging from at least 10 minutes to not greater than about 60 minutes.

Activities 417 through 419 can be performed using any of the embodiments described above in relation to FIG. 3 such that a polycrystalline doped lutetium aluminum garnet material is produced.

The resulting polycrystalline doped lutetium aluminum garnet material need not undergo any further heating operations prior to polishing during activity 412, but annealing can be conducted if desired. In an embodiment, the polycrystalline doped lutetium aluminum garnet material does not undergo any annealing or other heat treatment after sintering. In another embodiment, the polycrystalline doped lutetium aluminum garnet can be annealed after sintering for a period of time greater than 1 hour, but less than 20 hours, at a temperature ranging from about 1400° C. to about 1800° C. under an ambient or reducing atmosphere.

During activity 421, polishing of the polycrystalline doped lutetium aluminum garnet material can be performed. In an embodiment, the polycrystalline doped lutetium aluminum garnet material is polished on both sides. FIG. 9 shows an embodiment of polycrystalline doped lutetium aluminum garnet material, polished on both sides and having a diameter of approximately 15.5 mm and a thickness of approximately 4 mm.

The resulting polycrystalline doped lutetium aluminum garnet material has many useful properties, particularly with regard to use as a scintillator material, such as a higher transmission of electromagnetic radiation compared to other polycrystalline doped lutetium aluminum garnet materials of the same thickness. In an embodiment, the polycrystalline doped lutetium aluminum garnet material has a measurable maximum transmittance of electromagnetic radiation at one or more wavelengths of the electromagnetic spectrum. In another embodiment, the polycrystalline doped lutetium aluminum garnet is transparent in the visible light spectrum. In another embodiment, the polycrystalline doped lutetium aluminum garnet material has a (first) maximum transmittance of at least approximately 75% in the visible light spectrum; a (second) maximum transmittance of at least approximately 65% for wavelengths in a range of 350 nm to 420 nm; or any combination thereof, wherein the (first) maximum transmittance in the visible spectrum and the (second) maximum transmittance in the range of 350 nm to 420 nm are measured based on a sample thickness of 4 mm.

High levels of transmittance are significant in relation to the thickness of the sample because transmittance decreases with increasing thickness of a material. Sintered polycrystalline ceramics can possess a complicated microstructure including grains, grain boundaries, second phases, and pores. Any one of these features of the microstructure, alone, or in combination, can significantly degrade the optical properties of the polycrystalline material.

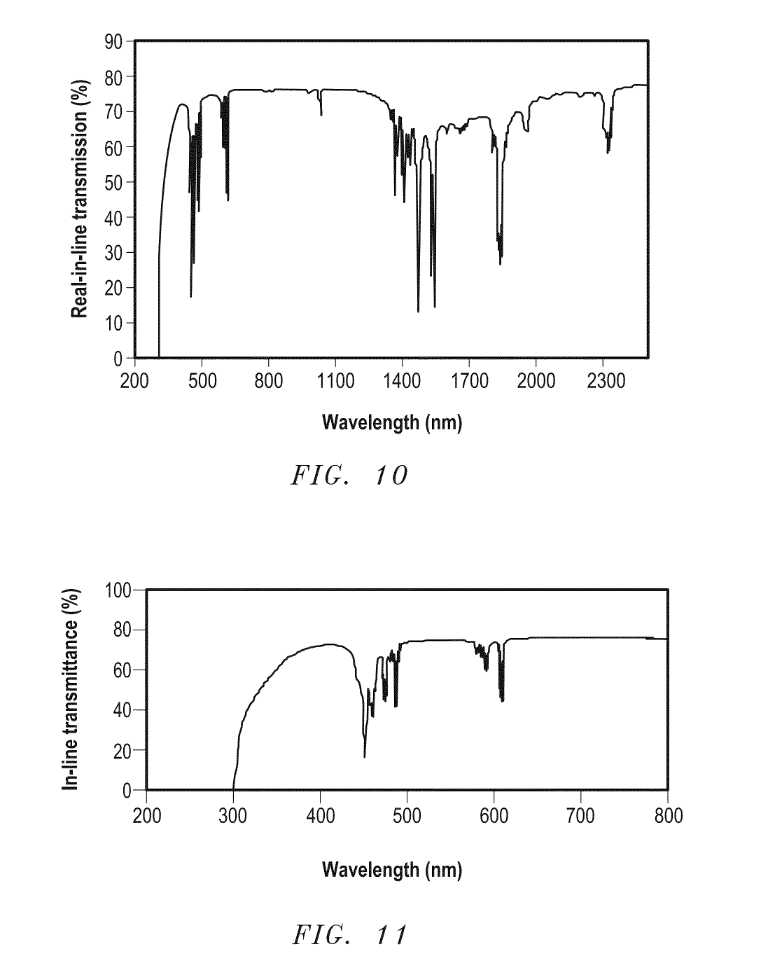

According to literature, the theoretical transmissivity of an ideal single crystal of lutetium aluminum garnet in the visible light spectrum is 83.3%. For comparison, FIG. 10 and FIG. 11 are graphs prepared using a UV-Vis-NIR spectrometer of percent transmittance of electromagnetic radiation according to wavelength for an embodiment of a polycrystalline doped LuAG material, namely a disk of LuAG:0.5% Pr, having a diameter of 15.5 mm and a thickness of approximately 4 mm FIG. 10 shows a maximum transmittance of greater than 75% in the visible light spectrum, a maximum transmittance of greater than approximately 70% for wavelengths in a range of 350 nm to 420 nm, and also a transmissivity approaching 80% in the near infrared portion of the spectrum. FIG. 11 shows a maximum transmittance of greater than 75% in the visible light spectrum, and a maximum transmittance of greater than approximately 70% for wavelengths in a range of 350 nm to 420 nm. FIG. 9 is a photograph of the 15.5 mm diameter, approximately 4 mm thick, LuAG:0.5% Pr disk which shows letters clearly visible and easily readable through the disk.

Turning to the physical characteristics of the polycrystalline doped lutetium aluminum garnet material, just as the shape and size of the green body can be varied, so to the shape and size of the resultant polycrystalline doped lutetium aluminum garnet material can be varied. In an embodiment, the length of scintillator material can range from at least about 0.5 mm to not greater than about 1000 mm. In another embodiment, the length of the scintillator material is in the range of about 5 mm to about 50 mm A particular embodiment is shown in FIG. 9, having a length (diameter) of approximately 15.5 mm.

In an embodiment, the width of the polycrystalline doped lutetium aluminum garnet material can be at least about 0.5 mm to not greater than about 1000 mm. In another embodiment, the width of the scintillator material is in the range of about 5 mm to about 50 mm A particular embodiment is shown in FIG. 9, having a width (diameter) of approximately 15.5 mm.

In an embodiment, the thickness of the polycrystalline doped lutetium aluminum garnet material is at least about 0.1 mm to not greater than about 100 mm. In a particular embodiment the thickness of the scintillator material is in the range of about 0.5 mm to about 10 mm A particular embodiment is shown in FIG. 9, having a thickness of approximately 4.0 mm.

In a particular embodiment, a scintillator material includes a doped polycrystalline lutetium aluminum garnet having a first maximum transmittance of at least approximately 75% in the visible light spectrum; a second maximum transmittance of at least approximately 65% for wavelengths in a range of 350 nm to 420 nm; or any combination thereof, wherein the first maximum transmittance and the second maximum transmittance are measured based on a sample thickness of 4 mm.

In a particular embodiment, a scintillator material includes a doped polycrystalline lutetium aluminum garnet having, when at a thickness of greater than 2.0 mm: a maximum transmittance of at least approximately 75% in the visible light spectrum; a maximum transmittance of at least approximately 65% for wavelengths in a range of 350 nm to 420 nm; or any combination thereof.

In another embodiment, a scintillator material includes a polycrystalline lutetium aluminum garnet doped with at least about 0.1 mole % to about 10 mole % of Ce, Pr, Tb, or combinations thereof; and wherein the scintillator material has: a maximum transmittance of at least approximately 75% in the visible light spectrum at a thickness of at least 2.5 mm; a maximum transmittance of at least approximately 65% for wavelengths in a range of 350 nm to 420 nm at a thickness of at least 2.5 mm; or any combination thereof.

In another embodiment, a method of forming a polycrystalline doped lutetium aluminum garnet material includes: mixing a doped lutetium oxide powder, an aluminum containing compound, a silicon containing compound, and a solvent to form a mixture; shape forming the mixture to form a green body; and sintering the green body to form the polycrystalline scintillator material.

In another embodiment, a method of making a polycrystalline doped lutetium aluminum garnet material includes: mixing a doped lutetium oxide powder, an aluminum containing compound, a silicon containing compound, and a solvent to form a mixture; granulating the mixture by adding a binder to form a granulated mixture; pressing the granulated mixture to form a green body; heating the green body to remove an organic material; and sintering the green body to form the polycrystalline scintillator material.

In another embodiment, a method of making a transparent polycrystalline doped lutetium aluminum garnet material includes: mixing a doped lutetium oxide powder, an aluminum oxide powder, a silicate compound, and a solvent to form a mixture; granulating the mixture by adding a binder to form a granulated mixture; dry pressing the granulated mixture to form a green body; conducting cold isostatic pressing of the green body; heating the green body to remove an organic compound; sintering the green body to form the polycrystalline doped lutetium aluminum garnet material; and polishing the polycrystalline doped lutetium aluminum garnet material.

### Example 1

### Synthesis of Lu₃Al₅O₁₂:0.5% Pr

The starting powders were weighed in order to obtain Lu_{2.985}Pr_{0.015}Al₅O₁₂.

High purity (99.99%) Lu₂O₃:0.5 at % Pr powder (˜0.4 wt % of Pr), 23.856 g, was obtained (Saint-Gobain Research (Shanghai) Co. Ltd.). High purity (99.99%) Al₂O₃ powder, 10.196 g, was obtained (Saint-Gobain Ceramics and Plastics, Inc., Worcester, Mass., USA). High purity (99.99%) Al₂O₃ beads, 200 g, was obtained (Saint-Gobain Ceramics and Plastics, Inc., Worcester, Mass., USA).

The Lu₂O₃:0.5 at % Pr powder had a density of 9.42 g/cm³ and a specific surface area of 15.3 m²/g. The average particle size of the Lu₂O₃:0.5 at % Pr powder was approximately 46 nm based on BET specific surface area; approximately 30 nm based on XRD, and in a range of approximately 40 to 50 nm based on SEM. The Lu₂O₃:0.5 at % Pr powder had a D50 of approximately 106 nm.

The Al₂O₃ powder had a density of 3.93 g/cm³ and a specific surface area of 22.7 m²/g. The average particle size of the Al₂O₃ powder was approximately 70 nm based on BET specific surface area and had a D50 of less than 100 nm.

The powders and beads were combined with 0.2 g of tetraethyl orthosilicate as a sintering aid, and 50 ml of anhydrous alcohol and ball milled for 11 hours at approximately 180 RPM in a Fritsch P5 planetary ball milling machine (Fritsch GmbH, Idar—Oberstein, Germany). The balls were aluminum oxide and had a 5:1 weight ratio to the weight of the powders and beads.

To improve handleability, the mixture was granulated by adding 10.5 g of 8.0 wt % PVA aqueous solution followed by drying and sieving.

The granulated mixture was dry pressed to form a 20 mm diameter disk in a double action die at a pressure of approximately 30 Mpa for approximately ten minutes.

The disk was removed and then cold-isostatically pressed by wet-bag method at a pressure of about 200 MPa for approximately 30 minutes.

The disk was removed and heat treated at 800° C. for two hours to remove organic materials.

The disk was then sintered in a vacuum furnace at a sintering temperature of about 1780° C. for about 12 hours. A transparent polycrystalline LuAG:0.5% Pr disk was obtained.

No annealing of the disk was performed.

The disk was polished on both sides to a minor finish, resulting in a disk, as shown in FIG. 9, with a diameter of 15.5 mm and a thickness of approximately 4 mm.

Transmittance of electromagnetic radiation was tested at wavelengths from 200 nm to approximately 2500 nm using a Cary 5000 UV-Vis-NIR spectrometer (Varian, USA). The maximum % transmittance in the visible light spectrum was greater than approximately 75% as shown in FIG. 10 and FIG. 11. Fluorescence spectrum excited by UV light source was measured using an FLSP920 spectrometer-fluorometer (Edinburgh Instruments, United Kingdom). The spectra indicated an excitation wavelength of approximately 283 nm and an emission wavelength of approximately 308 nm. Fluorescence decay spectra indicated a primary decay time of approximately 20.02 nano seconds.

Note that not all of the activities described above in the general description or the embodiments are required, that a portion of a specific activity can not be required, and that one or more further activities can be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments can also be provided in combination in a single embodiment, and conversely, various features that are, for brevity, described in the context of a single embodiment, can also be provided separately or in any subcombination. Further, reference to values stated in ranges includes each and every value within that range. Many other embodiments can be apparent to skilled artisans only after reading this specification. Other embodiments can be used and derived from the disclosure, such that a structural substitution, logical substitution, or another change can be made without departing from the scope of the disclosure. Accordingly, the disclosure is to be regarded as illustrative rather than restrictive.

1-77. (canceled)

78. A scintillator material comprising:
a doped polycrystalline lutetium aluminum garnet having, when at a thickness of greater than 2.0 mm:
a maximum transmittance of at least approximately 75% in the visible light spectrum;
a maximum transmittance of at least approximately 65% for wavelengths in a range of 350 nm to 420 nm; or
any combination thereof.

79. The scintillator material of claim 78, further having a maximum transmittance of at least approximately 75% for wavelengths in a range of 500 nm to 600 nm.

80. The scintillator material of claim 79, further having a maximum transmittance of at least approximately 75% for wavelengths in a range of 2000 nm to 2500 nm.

81. The scintillator material of claim 78, wherein the scintillator material is doped with a dopant that is a Lanthanide element.

82. The scintillator material of claim 78, wherein the scintillator material is doped with a dopant that is at least one of the group consisting of Ce, Pr, Tb, and combinations thereof.

83. The scintillator material of claim 78, wherein the scintillator material is doped with a dopant that is Ce, Pr, or Tb.

84. The scintillator material of claim 78, wherein the scintillator material is doped with a dopant that is Pr.

85. The scintillator material of claim 81, wherein the amount of dopant is in the range of about 0.1 mole % to about 3 mole %.

86. The scintillator material of claim 78, having a thickness is in the range of about 0.5 mm to 10 mm thickness.

87. The scintillator material of claim 78, wherein the scintillator material is in the form of at least one of the group consisting of a slab, a sheet, a disk, a rod, a cube, a rectangular prism, a tetrahedron, a pyramid, a cone, and a sphere.

88. A scintillator material comprising:
a polycrystalline lutetium aluminum garnet doped with at least about 0.1 mole % to about 10 mole % of Ce, Pr, Tb, or combinations thereof; and wherein the scintillator material has:
a maximum transmittance of at least approximately 75% in the visible light spectrum based on a sample thickness of at least 2.5 mm;
a maximum transmittance of at least approximately 65% for wavelengths in a range of 350 nm to 420 nm based on a sample thickness of at least 2.5 mm; or
any combination thereof.

89. A method of making a polycrystalline doped lutetium aluminum garnet material comprising:
mixing a doped lutetium oxide powder, an aluminum containing compound, a silicon containing compound, and a solvent to form a mixture;
shape forming the mixture to form a green body; and
sintering the green body to form the polycrystalline doped lutetium aluminum garnet material.

90. The method of claim 89, wherein the doped lutetium powder has a specific surface area ranging from not less than about 12 m²/g to not greater than about 17 m²/g.

91. The method of claim 89, wherein the doped lutetium powder has a density ranging from not less than about 9.3 g/cm³ to not greater than about 9.5 g/cm³.

92. The method of claim 89, wherein the doped lutetium powder has an averaged particle size of at least about 40 nm to not greater than about 46 nm.

93. The method of claim 89, wherein the doped lutetium powder has:
a specific surface area ranging from about 12 m²/g to about 18 m²/g;
a density ranging from about 9.3 g/cm³ to about 9.5 g/cm³; and
an averaged particle size ranging from about 40 nm to about 46 nm.

94. The method of claim 89, wherein the aluminum containing compound is an aluminum oxide powder.

95. The method of claim 89, wherein the silicon containing compound is tetraethyl orthosilicate.

96. The method of claim 89, wherein the sintering occurs under vacuum or in a hydrogen atmosphere.

97. The method of claim 96, wherein the sintering occurs at a sintering temperature in the range of at least about 1650° C. to not greater than about 1850° C.
